(19) United States
(12) Patent Application Publication
(10) Pub. No.: US 2026/0124893 A1
(43) Pub. Date: May 7, 2026

(54) VEHICLE UNDERBODY STRUCTURE

(71) Applicant: TOYOTA JIDOSHA KABUSHIKI KAISHA, Toyota-shi (JP)

(72) Inventor: Katsunori HIGASHIHARA, Toyota-shi (JP)

(73) Assignee: TOYOTA JIDOSHA KABUSHIKI KAISHA, Toyota-shi (JP)

(21) Appl. No.: 19/363,968

(22) Filed: Oct. 21, 2025

(30) Foreign Application Priority Data
Nov. 5, 2024 (JP) 2024-193626

(51) Int. Cl. B60K 1/04; B60L 58/10; B62D 21/03; B62D 25/02; B62D 25/14; H01M 10/48; H01M 50/249; H01M 50/271

(52) U.S. Cl. CPC B60K 1/04; B60L 58/10; B62D 21/03; B62D 25/025; B62D 25/14; H01M 10/48; H01M 50/249; H01M 50/271; B60K 2001/0438; B60L 2240/547; H01M 2220/20

(57) ABSTRACT

A vehicle underbody structure includes: a battery case mounted in a lower portion of a vehicle, at least a portion of an upper wall of the battery case also serving as a floor panel; a battery module housed within the battery case; and a detector housed within the battery case and configured to detect a voltage abnormality of the battery module. An opening configured to allow access to the detector is provided in the upper wall of the battery case, and a lid configured to open and close the opening is provided.

### CROSS-REFERENCE TO RELATED APPLICATION

This application claims priority to Japanese Patent Application No. 2024-193626 filed on Nov. 5, 2024. The disclosure of the above-identified application, including the specification, drawings, and claims, is incorporated by reference herein in its entirety.

### BACKGROUND

### 1.Technical Field

The present disclosure relates to vehicle underbody structures.

### 2. Description of Related Art

A battery electric vehicle provided with a battery case including a case rear having an opening and a case front removably closing the opening is conventionally known in the art (see, for example, Japanese Unexamined Patent Application Publication No. 10-255746 (JP 10-255746 A)).

### SUMMARY

In order to maintain or replace a detector configured to detect a voltage abnormality of a battery module housed within a battery case, it is necessary to remove the battery case from a battery electric vehicle and disassemble it. However, in a configuration in which the battery case is mounted in a lower portion of the vehicle, it is not easy to remove the battery case from the vehicle.

Accordingly, an object of the present disclosure is to provide a vehicle underbody structure that enables a detector configured to detect a voltage abnormality of a battery module housed within a battery case to be maintained or replaced without removing the battery case from a vehicle.

In order to achieve the above object, a vehicle underbody structure of a first aspect of the present disclosure includes: a battery case mounted in a lower portion of a vehicle, at least a portion of an upper wall of the battery case also serving as a floor panel; a battery module housed within the battery case; and a detector housed within the battery case and configured to detect a voltage abnormality of the battery module. An opening configured to allow access to the detector is provided in the upper wall of the battery case, and a lid configured to open and close the opening is provided.

In the first aspect of the disclosure, the battery case is mounted in the lower portion of the vehicle, and at least a portion of the upper wall of the battery case also serves as

the floor panel. The battery module and the detector configured to detect a voltage abnormality of the battery module are housed within the battery case. The opening configured to allow access to the detector is provided in the upper wall of the battery case, and the lid configured to open and close the opening is provided. With the above configuration, the detector can be accessed through the opening by removing the lid. Accordingly, maintenance or replacement of the detector can be performed without removing the battery case from the vehicle.

According to a vehicle underbody structure of a second aspect of the present disclosure, in the vehicle underbody structure of the first aspect, the opening is provided in the upper wall of the battery case at a position located, as viewed from a side in a vehicle width direction, between a dash panel that constitutes a front wall of a vehicle cabin and an accelerator pedal.

In the second aspect of the disclosure, the opening is provided in the upper wall of the battery case at a position located, as viewed from the side in the vehicle width direction, between the dash panel that constitutes the front wall of the vehicle cabin and the accelerator pedal. In other words, the opening is formed at a location that is not readily accessible by an occupant. This configuration reduces the risk that the lid may be inadvertently removed from inside the vehicle cabin by an occupant, thereby ensuring safety.

According to a vehicle underbody structure of a third aspect of the present disclosure, in the vehicle underbody structure of the second aspect, the opening is provided such that a longitudinal direction of the opening extends in the vehicle width direction, and an upper surface of a front cross member extending between a pair of right and left rockers at a position below the dash panel in a vehicle up-down direction is substantially flush with an upper surface of the upper wall of the battery case.

In the third aspect of the disclosure, the opening is provided such that its longitudinal direction extends in the vehicle width direction, and the upper surface of the front cross member extending between the right and left rockers at a position below the dash panel in the vehicle up-down direction is substantially flush with the upper surface of the upper wall of the battery case. This configuration makes it possible to achieve both suppression of an increase in the weight of the vehicle and reinforcement in the vicinity of the opening of the battery case to the greatest extent, compared to a case where the upper surface of the front cross member is not made substantially flush with the upper surface of the upper wall of the battery case. As used in the present disclosure, the term “flush” also includes “substantially flush” that includes minor offsets.

According to a vehicle underbody structure of a fourth aspect of the present disclosure, in the vehicle underbody structure of any one of the first to third aspects, the opening is provided such that a longitudinal direction of the opening extends in a vehicle width direction, and a cross portion extending in the vehicle width direction is provided in a portion of the interior of the battery case that is located closer to a lower wall of the battery case and faces the opening in a vehicle up-down direction.

In the fourth aspect of the disclosure, the opening is provided such that its longitudinal direction extends in the vehicle width direction, and the cross portion extending in the vehicle width direction is provided in the portion of the interior of the battery case that is located closer to the lower wall of the battery case and faces the opening in the vehicle up-down direction. This configuration makes it possible to effectively suppress a reduction in strength in the vicinity of the opening of the battery case, compared to a case where the cross portion is not provided.

As described above, according to the present disclosure, a detector configured to detect a voltage abnormality of a battery module housed within a battery case can be maintained or replaced without removing the battery case from a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic plan view showing a vehicle underbody structure according to an embodiment; and

FIG. 2 is a schematic side sectional view showing the vehicle underbody structure according to the embodiment.

### DETAILED DESCRIPTION OF EMBODIMENTS

Hereinafter, an embodiment according to the present disclosure will be described in detail with reference to the drawings. For convenience of description, in the drawings, an arrow UP indicates the upward direction of the vehicle, an arrow FR indicates the frontward direction of the vehicle, and an arrow RH indicates the rightward direction of the vehicle. Unless otherwise specified, references to the up-down, front-rear, or left-right directions in the following description refer to the up-down, front-rear, and left-right directions of the vehicle, respectively. The left-right direction is synonymous with the vehicle width direction.

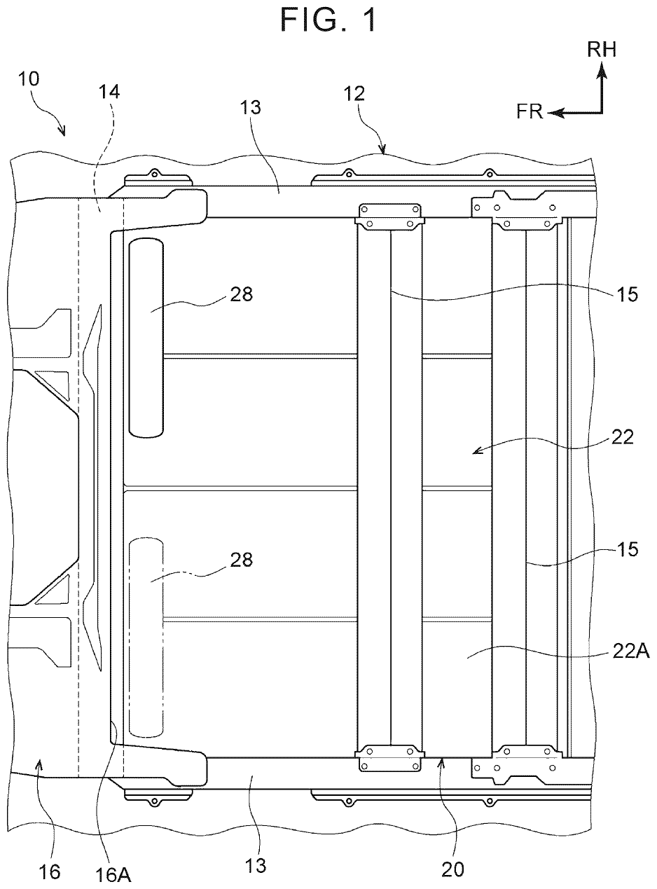

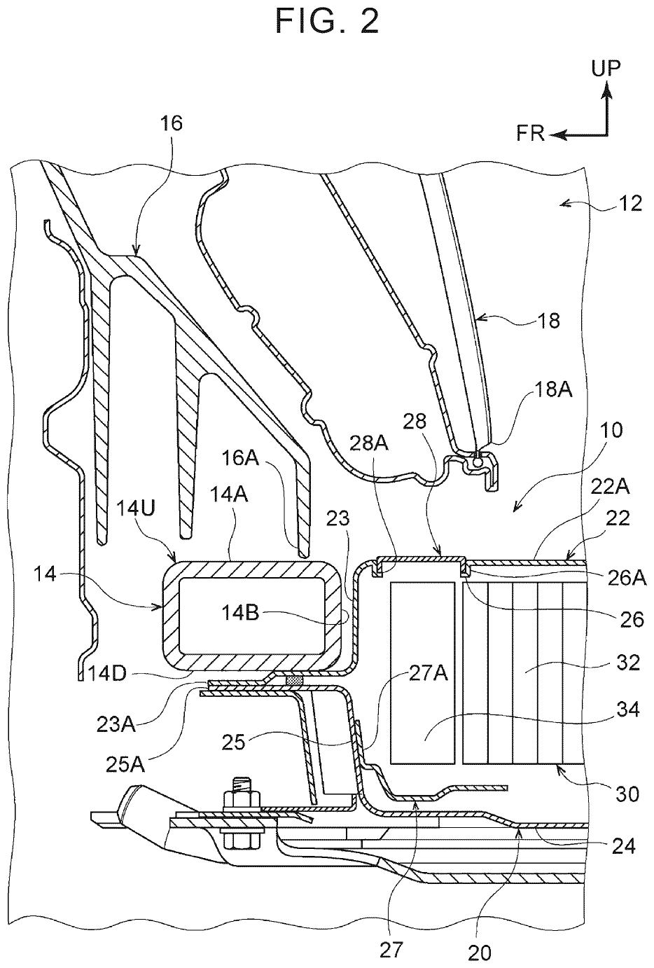

As shown in FIGS. 1 and 2, a vehicle underbody structure 10 according to the present embodiment is applied to a vehicle 12 such as a battery electric vehicle that includes a battery case 20. The battery case 20 is mounted in a lower portion of the vehicle 12. As shown in FIG. 2, the battery case 20 includes an upper wall 22 and a lower wall 24. An upper peripheral wall 23 extends downward integrally from a peripheral edge of the upper wall 22, and a lower peripheral wall 25 extends upward integrally from a peripheral edge of the lower wall 24.

An upper flange 23A is integrally formed to project outward from a peripheral edge of the upper peripheral wall 23, and a lower flange 25A is integrally formed to project outward from a peripheral edge of the lower peripheral wall 25. The battery case 20 is formed into a substantially rectangular box shape by placing the upper flange 23A on the lower flange 25A and joining them.

As shown in FIG. 1, at least a portion of the upper wall 22 is exposed, for example, between a plurality of cross members 15 extending between a pair of right and left rockers 13, and also serves as a floor panel of the vehicle 12. The vehicle 12 according to the present embodiment is, as one example, a right-hand drive battery electric vehicle in which a driver's seat is provided on the right side.

As shown in FIG. 2, the battery case 20 houses a battery module 30 in which a plurality of battery cells 32 is stacked, and a detector 34 configured to detect a voltage abnormality of the battery module 30. The detector 34 is disposed on the driver's seat side (right side) in a front end portion of the interior of the battery case 20, and the battery module 30 is disposed rearward of the detector 34.

An opening 26 configured to allow access to the detector 34 is formed on the driver's seat side (right side) in a front end portion of the upper wall 22 of the battery case 20, and a lid 28 configured to open and close the opening 26 is provided. As viewed in plan, the opening 26 is formed in a substantially rectangular shape such that its longitudinal direction extends in the vehicle width direction, and the lid 28 is formed in the shape of a substantially rectangular flat plate such that its longitudinal direction extends in the vehicle width direction (see FIG. 1).

As shown in FIG. 2, a short cylindrical portion 26A extending downward is integrally formed on a peripheral edge of the opening 26, and a short cylindrical portion 28A extending downward is also integrally formed on a peripheral edge of the lid 28. The outer diameter of the short cylindrical portion 28A of the lid 28 is slightly larger than the inner diameter of the short cylindrical portion 26A of the opening 26.

The lid 28 is thus configured to close the opening 26 by fitting (press-fitting) the short cylindrical portion 28A of the lid 28 into the short cylindrical portion 26A of the opening 26 with a predetermined friction (sliding resistance) generated therebetween. In other words, this configuration enables the opening 26 to be opened and closed by the lid 28.

As shown in FIG. 2, the opening 26 of the battery case 20 is formed in the upper wall 22 of the battery case 20 at a position located, as viewed from the side in the vehicle width direction, between a lower end 16A on the vehicle cabin side of a dash panel 16 that forms a front wall of the vehicle cabin and a lower end 18A of an accelerator pedal 18. In other words, as viewed from the side, a front end of the upper wall 22 of the battery case 20 is located between the lower end 16A on the vehicle cabin side of the dash panel 16 and the lower end 18A of the accelerator pedal 18.

A cross portion 27 extending in the vehicle width direction is provided in the front end portion of the interior of the battery case 20 at a position closer to the lower wall 24 (a position facing the opening 26 in the up-down direction). The cross portion 27 is formed of a metal plate bent into a substantially L-shaped cross-section, and a front end portion 27A of the cross portion 27 is joined to a front wall of the lower peripheral wall 25 by welding etc. The detector 34 is disposed above the cross portion 27. In other words, the detector 34 is disposed between the cross portion 27 and the lid 28.

A front cross member 14 having a closed cross-sectional shape and extending in the vehicle width direction is provided at a position below the dash panel 16 to extend between the right and left rockers 13 (see FIG. 1). The battery case 20 is mounted with the upper peripheral wall 23 positioned close to a rear wall 14B of the front cross member 14, and the upper flange 23A of the upper peripheral wall 23 is joined to a lower wall 14D of the front cross member 14 from below. As viewed from the side, an upper surface 14A of an upper wall 14U of the front cross member 14 is made substantially flush with an upper surface 22A of the upper wall 22 of the battery case 20 (see FIG. 2).

The functions of the vehicle underbody structure 10 according to the present embodiment having the above configuration will now be described.

As described above, the battery case 20 is mounted in the lower portion of the vehicle 12, and at least a portion of the upper wall 22 also serves as the floor panel. The battery case 20 houses the battery module 30 and the detector 34 configured to detect a voltage abnormality of the battery module 30. The opening 26 configured to allow access to the detector 34 is formed in the upper wall 22 of the battery case 20, and the lid 28 configured to open and close the opening 26 is provided.

With the above configuration, a worker can access the detector 34 through the opening 26 by removing the lid 28 (i.e., by exposing the opening 26). According to the present embodiment, maintenance or replacement of the detector 34 can thus be performed without removing the battery case 20 from the vehicle 12.

The opening 26 is formed in the upper wall 22 of the battery case 20 at a position located, as viewed from the side in the vehicle width direction, between the lower end 16A on the vehicle cabin side of the dash panel 16 and the lower end 18A of the accelerator pedal 18. In other words, the opening 26 is formed at a location that is not readily accessible by an occupant (i.e., a location that cannot be accessed unless the accelerator pedal 18 is removed). This configuration reduces the risk that the lid 28 may be inadvertently removed from inside the vehicle cabin by an occupant, thereby ensuring safety.

The cross portion 27 extending in the vehicle width direction is provided in the front end portion of the interior of the battery case 20 at a position closer to the lower wall 24 (a position facing the opening 26 in the up-down direction). This configuration makes it possible to effectively suppress a reduction in strength in the vicinity of the opening 26 of the battery case 20, compared to a case where the cross portion 27 is not provided.

Furthermore, the upper surface 14A of the upper wall 14U of the front cross member 14 extending between the right and left rockers 13 at a position below the dash panel 16 is made substantially flush with the upper surface 22A of the upper wall 22 of the battery case 20. This configuration makes it possible to achieve both suppression of an increase in the weight of the vehicle 12 and reinforcement in the vicinity of the opening 26 of the battery case 20 to the greatest extent, compared to a case where the upper surface 14A of the upper wall 14U of the front cross member 14 is not made substantially flush with the upper surface 22A of the upper wall 22 of the battery case 20.

Specifically, when the upper surface 14A of the upper wall 14U of the front cross member 14 is positioned higher than the upper surface 22A of the upper wall 22 of the battery case 20 (i.e., when the front cross member 14 is made larger than that shown in the figure), the weight of the front cross member 14 inevitably increases, resulting in an increase in the weight of the vehicle 12.

On the other hand, when the upper surface 14A of the upper wall 14U of the front cross member 14 is positioned lower than the upper surface 22A of the upper wall 22 of the battery case 20 (i.e., when the front cross member 14 is made smaller than that shown in the figure), the reinforcing effect in the vicinity of the opening 26 of the battery case 20 is reduced.

In the vehicle underbody structure 10 according to the present embodiment, since the upper surface 14A of the upper wall 14U of the front cross member 14 is made substantially flush with the upper surface 22A of the upper wall 22 of the battery case 20, it is possible to effectively reinforce the vicinity of the opening 26 of the battery case 20 while suppressing an increase in the weight of the vehicle 12.

Although the vehicle underbody structure 10 according to the present embodiment has been described above with reference to the drawings, the vehicle underbody structure 10 is not limited to the illustrated example, and various design modifications may be made without departing from the spirit and scope of the present disclosure. For example, in the case where the vehicle 12 is a left-hand drive battery electric vehicle, the detector 34 is disposed on the driver's seat side (left side) of the battery case 20. Therefore, as indicated by the phantom line in FIG. 1, the lid 28 (and the opening 26) is provided on the left side of the battery case 20. The lid 28 may be pivotably attached at its front end to the upper wall 22 of the battery case 20 so as to pivot about an axis extending in the vehicle width direction.

What is claimed is:

1. A vehicle underbody structure comprising:
a battery case mounted in a lower portion of a vehicle, at least a portion of an upper wall of the battery case also serving as a floor panel;
a battery module housed within the battery case; and
a detector housed within the battery case, the detector being configured to detect a voltage abnormality of the battery module,
wherein an opening configured to allow access to the detector is provided in the upper wall of the battery case, and a lid configured to open and close the opening is provided.

2. The vehicle underbody structure according to claim 1, wherein the opening is provided in the upper wall of the battery case at a position located, as viewed from a side in a vehicle width direction, between a dash panel that constitutes a front wall of a vehicle cabin and an accelerator pedal.

3. The vehicle underbody structure according to claim 2, wherein:
the opening is provided such that a longitudinal direction of the opening extends in the vehicle width direction; and
an upper surface of a front cross member extending between a pair of right and left rockers at a position below the dash panel in a vehicle up-down direction is substantially flush with an upper surface of the upper wall of the battery case.

4. The vehicle underbody structure according to claim 1, wherein:
the opening is provided such that a longitudinal direction of the opening extends in a vehicle width direction; and
a cross portion extending in the vehicle width direction is provided in a portion of an interior of the battery case, the portion being located closer to a lower wall of the battery case and facing the opening in a vehicle up-down direction.
